(19) United States
(12) Patent Application Publication
(10) Pub. No.: US 2004/0049339 A1
(43) Pub. Date: Mar. 11, 2004

(54) Assistance system for selecting routes

(76) Inventors: Markus Kober, Ennigerloh (DE); Werner Kuhn, Muenster (DE); Martin Mueller, Bempflingen (DE); Christoph Ruether, Muenster (DE); Dieter Vollmer, Schorndorf (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/332,042

(22) PCT Filed: Jun. 21, 2001
(86) PCT No.: PCT/EP01/07026

(30) Foreign Application Priority Data
Jul. 4, 2000 (DE) 10031787.1

(51) Int. Cl. G01C 21/26

(52) U.S. Cl. 701/209; 701/200

(57) ABSTRACT

The invention relates to an assistance system for selecting a route with the aid of a computing device, a storage device and an input and output device, each route being described by route parameters influencing the journey and stored in the storage device, and whose computing device selects a specific route after an input of search criteria and outputs it via the output device. It is proposed according to the invention that the computing device uses the route parameters influencing the journey to determine macroscopic route features for each route which can be interrogated by the input of search criteria for macroscopic route features.

### BACKGROUND AND SUMMARY OF THE INVENTION

This application claims the priority of German patent document 100 31 787.1, filed Jul. 4, 2000 (PCT International Application No. PCT/EP01/07026, filed Jun. 21, 2001), the disclosure of which is expressly incorporated by reference herein.

The invention relates to an assistance system for selecting routes for a vehicle.

German patent document DE 43 44 369 C2 discloses an assistance system for selecting a route with the aid of a computing device, a storage device and an input and output device. Each route is described by stored route parameters that influence the journey. A specific route is selected by the computing device, and output via an output device after an input of prescribed criteria, by comparing route parameters that influence the journey. It is possible to prescribe as criteria a particularly low energy consumption or as short a driving time as possible.

One object of the invention is to provide a route selection assistance system which permits a differentiated search for a route with prescribed route properties, enhancing the convenience for the user in selecting routes.

This and other objects and advantages are achieved by the route selection system according to the invention, in which route parameters that influence a journey are stored in a digital map in the form of various attributes, and are used for example, to calculate macroscopic route features. The routes are then classified based on these macroscopic route features. By inputting the desired macroscopic route features, a vehicle operator may search for and select a specific route based on a comparison of such macroscopic route features.

Important route parameters that influence a journey are, for example, topographic parameters such radii of curvature and inclines; traffic regulating parameters such as speed limits, passing bans and rights of way; structural parameters, such as number of lanes, road type (federal highway, country and urban roads), roadway width and route visibility. The route parameters influencing the journey are acquired quasi-continuously, for example, by random sampling vehicles in the form of FCD (floating car data), conditioned and stored. Other sources such as road construction offices, road maps, other maps, etc. can also be used in addition, for this purpose. The continuously acquired route parameters influencing the journey yield a detailed route description which is very helpful for simulations, calculations or other evaluations. A comparison of two routes or a classification is possible, however, only with difficulty because of the quantity of data.

The continuously acquired route features that influence the journey as set forth above are used, for example, to calculate as macroscopic route features the horizontal line trace (curviness, proportion of curves, classification of the line trace), the vertical line trace (mean incline, upgrade and downgrade sections, maximum incline), the percentages valid by section for speed limitations, overtaking bans, road type and number of lanes, the frequencies of locally valid features for rights of way (traffic lights, stop signs, etc.) and the dynamic pilot speed (mean value and variance as well as positive speed differences).

In a further embodiment of the invention, the route selection assistance system is part of a navigation system that accesses the assistance system to select, from among a plurality of alternatively possible routes; an optimal route between the prescribed starting and target points. The selected route is then used for the further navigation. In addition to known prescribed criteria, such as for example, low consumption, the fastest possible connection or shortest distance between starting and target points, the selection can also be a function of the stipulation of macroscopic route features. In this case, the corresponding devices of the navigation system can be used as input and output devices for the assistance system. In addition, it is possible to use the calculated dynamic pilot speed to calculate the likely travel time for a route or a route section.

In a particularly advantageous variant of the invention, the macroscopic route features for arbitrarily designated partial routes or “length intervals” (for example for length intervals of 1 km in length, or for an overall route from A to B) are calculated and stored.

Specific macroscopic route feature intervals may be prescribed for test drives when testing a vehicle, for example, in order to maximize the component loading on the basis of the route guidance or in order to find a new route with equivalent loading. A search is then made within the detected routes for partial routes whose macroscopic route features lie within the prescribed interval boundaries.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of an assistance system for route selection according to the invention;

FIG. 2 illustrates the calculation of the curviness of a route;

FIG. 3 shows the mean incline of a route section;

FIG. 4 shows differences in speed and route in the case of an accelerating movement; and

FIG. 5 shows an example of a dynamic pilot speed profile, with acceleration and deceleration curves.

### DETAILED DESCRIPTION OF THE DRAWINGS

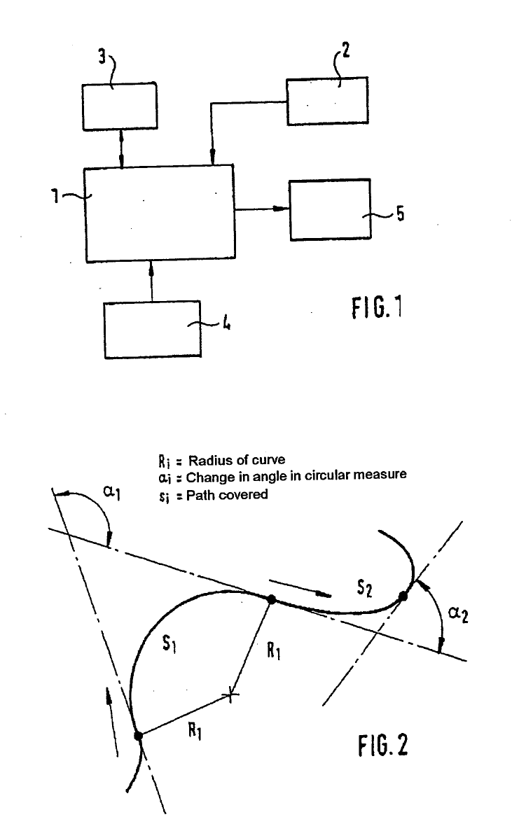

As may be seen from FIG. 1, the route selection assistance system according to the invention comprises a computing device 1, a storage device with the acquired route parameters 2, for example, a CD ROM with appropriate reading devices, and a storage device for storing the determined macroscopic route features 3. An input device 4 and an output device 5 may be combined in one unit.

The manner in which the macroscopic route features are determined by the computing device 1 is described below, with reference to FIGS. 2 to 5.

It is possible to determine macroscopic route features by statistical evaluation and classification of continuously acquired route parameters. Different routes can be described more effectively and compared objectively with the aid of the macroscopic route features. The macroscopic route features for specific route section lengths, so-called length intervals, are calculated for two different routes. The calculation permits length intervals of arbitrary size. The basic standard applied is a length interval of one kilometer. It is thereby possible, on the one hand, to represent route profiles of the macroscopic route features, while on the other hand two partial routes over which the length intervals extend completely can be compared objectively with the aid of the macroscopic route features. If length intervals extend over the entire route between A and B, they can be compared and described.

The macroscopic route intervals are classified according to their horizontal and vertical line traces, the macroscopic route features valid for a section and valid for a location, and the dynamic pilot speed.

In the following calculations, si denotes the route difference between two measuring points of continuously acquired route parameters. In order to calculate the macroscopic route features in a length interval, as many measuring points of continuously acquired route parameters are used as are required for their route differences to correspond to the length interval. The determination of n is defined mathematically as follows:

$${\sum }_{i = 1}^{n - 1} S i < Length interval \leq {\sum }_{i = 1}^{n - 1} S i \qquad ( Condition 1 )$$

The horizontal line trace influences the speed selection, the speed fluctuations and thus the selection of the gears and the fuel consumption of the vehicle. The consumption is additionally raised when the steering servo is strongly loaded due to curvy routes. The extra consumption can be up to 8%, depending on the type of steering servo. The profile of a route in the layout map is described by the macroscopic route features of curviness, proportion of curves and classification of the line trace.

The curviness is the sum of the absolute changes in angle per unit length in gon/km (400 gon=360□ (angular measure)=2π (circular measure)). FIG. 2 illustrates the calculation of the curviness.

The curve radii for left-hand and right-hand curves are represented by positive and negative values. If a change in type of curve occurs in the route trace, for example, a change from a left-hand to a right-hand curve, the angle ai, conditioned by the curve, of the overall change in direction is calculated with the aid of two tangents:

$$\frac{Route difference}{Radius of curve} = \frac{S i}{R i} = α i ( change in angle in circular measure )$$

The corresponding change in angle βi in gons is yielded as:

$${β}_{i} = \frac{200 \times {α}_{i}}{π} = \frac{200}{π} \times \frac{{s}_{i}}{{R}_{i}}$$

In order to calculate the curves in the length interval, the sum of the absolute changes in angle is divided by the sum of the route differences si and normalized in gon/km:

$$Curviness [ gon \text{/} k m ] = \frac{{\sum }_{i = 1}^{n} \vert β i \vert [ gon ]}{{\sum }_{i = 1}^{n} S i [ m ]} \times 1000 [ m \text{/} k m ]$$

(n in accordance with condition 1)

The proportion of curves is the percentage length component of the curves in the length interval. In this case, account is taken only of curves with radii smaller than 500 m, because in the case of larger radii, there is, as a rule, no influence of the route on the driving speed, because of the driving dynamics.

The horizontal line trace is classified using the criteria of wide and continuous, tight but continuous, or discontinuous and tight. The classification of the horizontal line trace is determined with the aid of the curviness and the proportion of the curves, as may be seen from Table 1.

TABLE 1
Classification of the horizontal line trace

| In the case of: | Test | Class |
|---|---|---|
| — | Curviness < | Wide and |
| | 250 gon/km | continuous |
| Curviness > | Curviness < | Tight but |
| 250 gon/km | 350 gon/km or | continuous |
| | Curviness < 5 × | |
| | Proportion of curves + | |
| | 100 gon/km | |
| Curviness > | — | Discon- |
| 350 gon/km and | | tinuous and |
| Curviness > 5 × | | tight |
| Proportion of curves + | | |
| 100 gon/km | | |

The proportion of curves must be taken into account, since given the same curviness the speeds travelled fall as the proportion of curves sinks. A low proportion of curves means that although there are more straight lines in a section, because of the same curviness the curves must be tighter on average and so the handling is discontinuous overall. The line trace is generally discontinuous starting from 600 gon/km.

Wide and continuous route traces permit the route section to be travelled at a permissible maximum speed of 100 km/h outside built up areas without the line trace having the effect of reducing speed.

Tight, but continuous line traces lead to a constant driving style without long acceleration or deceleration phases at a speed level below the permissible maximum speed. The line trace acts in this case to reduce speed.

Routes with a discontinuous and tight line trace exert a substantial influence on the speed selection, with large speed differences being possible due to unfavorable relationships between radii. The profile is characterized by frequent deceleration and acceleration processes.

The speed on country roads is also influenced by the vertical line trace. Maximum speeds are reached, depending on the vehicle, at a 2% downgrade and the speeds decrease continuously for upgrades starting from 4%, whereas the uniformity of the speed profile increases. Upgrades load the entire drive train from the radiator up to the lateral wheel shafts, and influence the consumption considerably. It is chiefly the brakes which are loaded in the case of downgrades. The vertical line trace is described by the macroscopic route features of mean incline, upgrade and downgrade components and the maximum inclines.

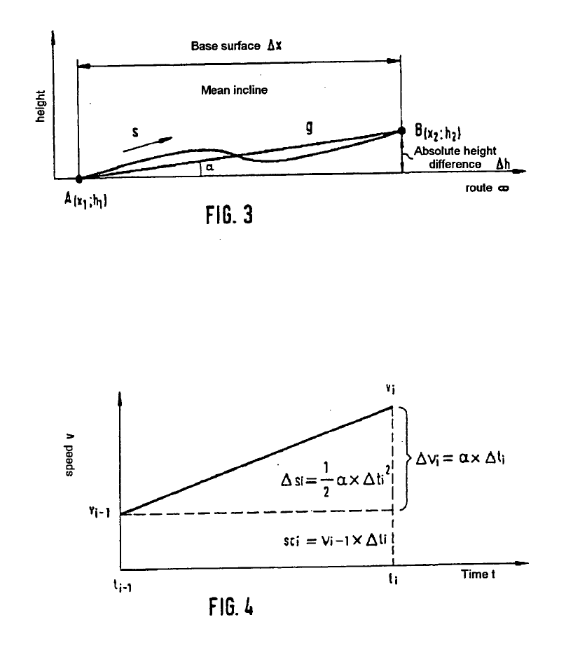

The mean incline describes the tendency of a journey on a route section. If the length interval extends over a complete circular course, the mean incline is trivially approximately zero. As a vehicle moves on, the two forms of energy constituting kinetic energy and potential energy occur. Travelling upgrades requires raising work, and this work can be recovered in downgrade sections. The energy balance of a vehicle is determined with the aid of the mean incline, which is determined between the starting point and end point of a length interval, see FIG. 3.

The points A and B form the initial and final elevations for the length interval illustrated. The following formula is used to determine the mean incline between the two points:

$$\begin{matrix}mean incline [ \% ] = 100 \times \frac{Δ h}{Δ x} = 100 \times tan α \\ = 100 \times tan ( arcsin \frac{Δ h}{g} )\end{matrix}$$

The approximation: sin(α)(a)□ tan (60 □ is permissible for angles of up to 10□, which corresponds to an upgrade or downgrade of approximately 17% in the case of physical and technical calculations. Consequently, the slight length differences between g and Δx can also be neglected, as can therefore, also the length differences between g and the route s actually traveled. It holds approximately that:

$$Mean incline [ \% ] = 100 \times tan ( arcsin \frac{Δ h}{s} )$$

The upgrade and downgrade sections are split into four classes each with the aid of empirical results and calculations relating to the driving dynamics. The influences on driving speeds and gear selection are the essential criteria in this case Table 2.

TABLE 2
Gradient classes in relation to the
influencing of speed and gear

Overall influences on

| Class | driving speed | gear selection |
|---|---|---|
| 0-2% | — | — |
| 2-5% | slight | — |
| 5-8% | strong | slight |
| >8% | strong | strong |

The macroscopic route feature of upgrade and downgrade components describes the percentage length components of the upgrade and downgrade classes in the length interval. The mean incline is determined for all route differences si in the length interval and assigned to the abovenamed classes. The sum of the route differences of each class is used to determine their percentage length components in the length interval.

The maximum upgrade and the maximum downgrade are determined within a length interval. These are measures of the peak loads produced.

The continuously detected route parameters of speed limitation, passing ban, type of road and number of lanes are applicable to route sections of different length. The corresponding macroscopic route features are the percentage length components of such sections over the entire length interval.

The speed limitations are prescribed explicitly by signs, or implicitly. Implicit speed limitations are, for example, the permissible maximum speed of 50 km/h for motor vehicles within built-up areas, 100 km/h for motor vehicles up to 3.5 t outside built up areas, and 60 km/h for motor vehicles of higher total weight.

For sections with the same, explicitly or implicitly prescribed maximum speed, the percentage length component in the length interval is determined. This calculation is carried out for all statutorily customary maximum speed stipulations (30 km/h, 40 km/h, 50 km/h, 60 km/h, etc.).

Frequently changing speed limitations influence the speed selection, the gear speeds and the consumption, since normally a vehicle is braked when driving into an area with a speed restriction and reaccelerated when leaving it. Conversely, an extended speed limitation tends to lead to a calm driving style which reduces consumption. These effects are accurately acquired by the dynamic pilot speed defined further below.

The percentage length component of the passing bans in the length interval is determined as a macroscopic route feature. Passing bans are marked by signs and with the aid of unbroken lines.

Driving in no-passing zones necessitates more uniform driving than in sections free from a passing ban. In the latter, higher accelerations and speeds are to be expected because of a greater number of passing maneuvers, actions and thus higher motor speeds are to be expected. This results in loading of the drive train, changes in the gear proportions and a higher consumption.

The individual types of road in the German federal road network are classified in terms of urban roads, country roads and federal motorways. The macroscopic route feature consists of the percentage length components of each type of road (country or urban roads or motorways) in the length interval. By contrast with journeys outside towns, journeys through towns necessitate a slower driving style, and a higher frequency of rules for rights of way (for example, traffic lights, pedestrian crossings etc.) and other disturbances to the traffic flow also occur. Speeds, accelerations and gears in towns can fluctuate more strongly, and this chiefly affects the drive train loading, gear proportions, gear changing frequencies and consumption.

The German road network outside towns consists of more than 90% single-lane roads. The further fractions are chiefly distributed among two-lane roads, with three-and multi-lane roads occurring rather more seldom. Each number of lanes (1-,2-or 3-and multi-lane) in a driving direction forms a class. The macroscopic route feature is the percentage length component of each class in the length interval.

As a rule, multiple lanes in a driving direction permit the individually targeted desired speed to be reached over lengthy time intervals. Certainly, passing maneuvers operations are more frequent, but are not characterized by such intense acceleration processes and changes in speed as in the case of passing on lanes with oncoming traffic. Multi-lane roads therefore give rise to a more uniform speed profile at a relatively high level, large fractions of high gears with few gear changes and lower drive train loadings because of the moderate acceleration process. This leads in conjunction with the same travel times to lower consumption than in the case of single-lane roads.

The locally valid parameters of observe right of way, stop, traffic lights, priority on the right, pedestrian crossing and grade crossing are detected in a fashion controlled by events in the continuous acquisition of the route parameters. The speed must frequently be substantially reduced at these points. The frequency per kilometer is defined for all locally valid parameters as macroscopic route feature.

The dynamic pilot speed describes driving speed as a function of the statutorily prescribed maximum speeds, the speeds in curves and the accelerations and decelerations customary in traffic. Other traffic influences such as vehicles driving in front, traffic lights etc. are not taken into account.

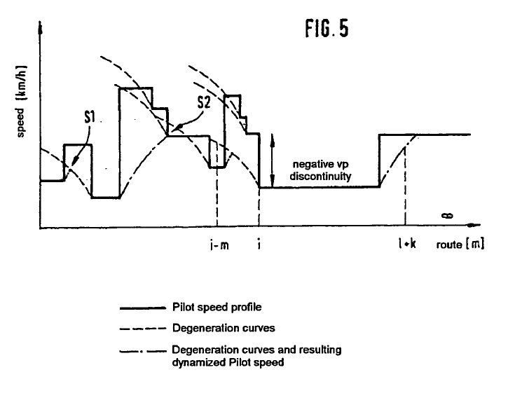

By definition, the pilot speed has speed discontinuities (FIG. 5) which are achieved only by infinite accelerations and decelerations of a vehicle. Consequently, a dynamic pilot speed is calculated which takes account of mean accelerations and decelerations customary in traffic. The dynamic pilot speed is used to calculate as macroscopic route features: a mean dynamic pilot speed, a variance of the dynamic pilot speed and a speed difference in the dynamic pilot speed.

These macroscopic route features influence the drive train loading, gear proportions, gear change frequencies and braking, as caused by strong fluctuations in the speeds with acceleration processes and braking processes. The rules of calculation for the pilot speed and the dynamic pilot speed are described below.

The guidelines for laying out roads prescribe minimum radii which may not be undershot, in order to make it possible to travel a road safely and confidently at a planned design speed. On a dry roadway, the design speeds can be exceeded by 20%, since the drivers partially compensate the safety redundancy provided.

When cornering, the lateral acceleration, which is a function of speed and the radius of the curve, has an effect on driver and the vehicle. In the case of wide curves, driven over more quickly, with large radii, the lateral accelerations accepted are not so large as in the case of tight curves driven over more slowly. Here, the driver feels safer because of the low speed and permits larger lateral accelerations. Accepted lateral accelerations of 0.15 to 0.4 g can be assumed for a normal driver. The accepted lateral acceleration depends on the driver, because experienced Formula 1 drivers drive up to the limit of lateral acceleration of 0.95 to 1.0 g, which the normal driver perceives as unpleasant and risky. The speed in the curve, which depends on radius and lateral acceleration, is calculated as follows for a normal and Formula 1 driver for the ith route difference.

Firstly, the accepted lateral acceleration of a driver is determined via the “loaded lateral coefficient of friction μi”. The latter decreases more and more with increasing radii. The effect of the decreasing lateral acceleration in the case of wide curves traversed quickly is modeled thereby.

In order to calculate the loaded lateral coefficient of friction μi for normal drivers, it is possible to set up the following regression equation which takes account of the design speed formulation and the results of measured speeds in the curve:

$${μ}_{i} = 0.3 \times {ⅇ}^{- 0.045 ( \frac{R i}{10} - 1 )} + 0.15$$

The loaded lateral coefficient of friction of the Formula 1 driver is fixed at a constant 0.9. If μi is fixed, the speed vi in the curve on a dry road can be calculated as follows:

νᵢ=\sqrt{μi×Ri×g}

μi= lateral coefficient of friction, Ri =radius of curve (m),

g=acceleration due to gravity [m/s²].

In the case of routes with tight radii of curvature, the targeted speed in the curve is frequently lower than the statutorily prescribed maximum speed. In order to determine the targeted speed on a route difference, the minimum is formed of the statutory speed limitation and the above described speed in the curve which depends on the driver. This minimum is denoted as pilot speed. The pilot speed is determined for the normal driver and the Formula 1 driver. In this case the appropriate speed in the curve is used in each case for forming the minimum.

Since only a general advisory speed of 130 km/h exists on highways, the pilot speeds are formed only from the high speeds in curves typical of highways. In order to avoid extremely high pilot speeds, a maximum speed of 180 km/h is prescribed on highways.

In order to avoid speed discontinuities, a basis is taken of speed differences Δvi which are possible in the case of accelerations of 1 m/s² and decelerations of −2 m/s² customary in traffic, within a route difference si. The calculation of the route differences and speed differences is first derived from the laws of motion.

FIG. 4 describes the change in distance and speed in a time interval in the case of an accelerator motion. The area under the graph corresponds to the route difference si in the case of accelerations from vi−1 to vi between the instants ti−1 and ti. The following relationships result:

$$\begin{matrix}Δ {v}_{i} = α \times Δ {t}_{i} & ( Equation 1 ) \\ S i = S C i + {Δ}_{s i} = {v}_{i - 1} \times Δ {t}_{i} + \frac{1}{2} α \times Δ {t}_{i}^{2} & ( Equation 2 ) \\ v i = {v}_{i - 1} + Δ {v}_{i} & ( Equation 3 )\end{matrix}$$

By substituting Δti in Equation 2, Δvi is yielded as:

Δνᵢ=−νᵢ₋₁+\sqrt{νᵢ₋₁²+2αΔsi} (Equation 4).

Equation 3 holds for positive and negative accelerations, with the boundary condition that: vi−1² +2aΔsi□0. vi results as follows from Equations 3 and 4:

νᵢ=\sqrt{νᵢ₋₁^{₂}+2αΔsi} (Equation 5).

It holds for vi−1 for a back calculation:

νᵢ−1=\sqrt{νi²−2αΔsi} (Equation 6).

The dynamic pilot speed vdi is calculated thereupon as follows:

First, the pilot speeds vpi are calculated from the minimum of the statutory speed limitation and the speed in the curve dependent on the driver. For all negative pilot speed discontinuities, Equation 6 is used to calculate backwards in conjunction with customary decelerations the initial speeds vi−m (m >1) up to approximately 400 m which lead to this vpi. The result is the dashed deceleration curves in FIG. 5. Reductions in speed of up to 144 km/h can be implemented on a 400 m route length in conjunction with decelerations of −2 m/s². Larger discontinuities are not normally to be expected in the pilot speed.

In the case of positive pilot speed discontinuities, the speed increase first corresponds to the calculated pilot speed before the discontinuity. For the following route points si+k (k>1), the speed is raised in accordance with Equation 5 with 1 m/s² until vdi+k cuts the smallest deceleration curve (S1) of a preceding negative pilot speed discontinuity, or the pilot speed profile vpi+k (S2) . At each route point si, the dynamic pilot speed vdi is the minimum of all existing acceleration and deceleration curves and of the calculated pilot speed vpi.

The mean dynamic pilot speed \overline{vd} [km/h] is the route-weighted arithmetic mean of the dynamic pilot speeds in the length interval:

$$\overline{v d} = \frac{1}{{\sum }_{i = 1}^{n} {s}_{i}} \times {\sum }_{i = 1}^{n} v {d}_{i} \times {s}_{i}$$

(n in accordance with condition 1)

For a length interval the variance per kilometer [km/h²] of the dynamic pilot speed describes the mean quadratic deviation of the individual values of the dynamic pilot speeds from their mean. The variance is a measure of the braking and acceleration processes within a length interval. In a fashion analogous to the variance customarily defined in statistics, the variance σ² of the dynamic pilot speed per kilometer is calculated as follows:

$${σ}^{2} = \frac{1}{n \times {\sum }_{i = 1}^{n} {s}_{i}} \times {\sum }_{i = 1}^{n} {( v {d}_{i} - \overline{v d} )}^{2} \times 1000$$

n in accordance with condition 1)

The speed difference per kilometer [1/h] of the dynamic pilot speed describes the positive changes in the dynamic pilot speed over the length interval, and therefore indicates the average accelerations possible. It is determined as a division of the sum of the positive changes in the dynamic pilot speed by the length of the length interval.

$$Speed difference = \frac{{\sum }_{k = 1}^{n} Δ v {d}_{k}^{T}}{{\sum }_{i = 1}^{n} Δ {s}_{i}}$$

(n in accordance with condition 1)

Table 4 shows an overview of the macroscopic route features.

TABLE 4
Tabular overview of the macroscopic route
features

| Macroscopic route | |
|---|---|
| features | Description |
| Curviness | Sum of the absolute changes |
| | in angle per length unit in |
| | gon/km in the length |
| | interval |
| Proportion of curves | Percentage length component |
| | of the curves with radii |
| | <500 m in the length |
| | interval |
| Classification of the | Classification of the |
| horizontal line trace | horizontal line trace with |
| | the aid of the curviness and |
| | the proportion of curves |
| Mean incline | “Tendency” of the journey: |
| | incline between beginning and |
| | end of a route section |
| Upgrade and downgrade | Percentage length |
| sections | components of upgrade and |
| | downgrade classes in the |
| | length interval |
| Maximum inclines | Maximum upgrade and |
| | downgrade within a length |
| | interval |
| Percentages of the | Percentage length |
| speed limitations | components of prescribed |
| | maximum speeds in the |
| | length interval |
| Percentages of the | Percentage length |
| overtaking bans | components of the |
| | overtaking bans in the |
| | length interval |
| Percentages of the | Percentage length |
| types of road | components of the |
| | motorways, urban or country |
| | roads in the length |
| | interval |
| Percentages of the | Percentage length |
| number of lanes | components of 1-, 2-, or |
| | 3- and multi-lane roads in |
| | the length interval |
| Locally valid | Frequency of locally valid |
| macroscopic route | parameters per km in the |
| features | length interval |
| Mean dynamized pilot | Route-weighted arithmetic |
| speed | mean of the dynamized pilot |
| | speeds in the length |
| | interval |
| Variance of the | Mean square deviation of |
| dynamized pilot speed | the individual values of |
| per km | the dynamized pilot speeds |
| | per km in the length |
| | interval |
| Difference in the | Positive changes in the |
| dynamized pilot speed | dynamized pilot speeds in |
| | the length interval |

Table 5 shows, by way of example, the results of the calculation of macroscopic route features for four different routes.

TABLE 5
Macroscopic route features

| | | | Route | | | |
|---|---|---|---|---|---|---|
| | | | 1 | 2 | 3 | 4 |
| | | Length (m) | 415400 | 439702 | 276104 | 48106 |
| | | Curviness | 152.4 | 74.1 | 47.7 | 239.0 |
| | | [gon/km] | | | | |
| | | Proportion of | 24.9 | 12.5 | 3.5 | 30.8 |
| | | curves (%) | | | | |
| Class [%] | | Wide and | 79.0 | 94.0 | 96.0 | 56.0 |
| | | continuous | | | | |
| | | Tight but | 11.0 | 4.0 | 2.0 | 18.0 |
| | | continuous | | | | |
| | | discontinuous and | 10.0 | 2.0 | 2.0 | 26.0 |
| | | tight | | | | |
| | | Mean incline [%] | 0.0 | −0.01 | 0.0 | 0.06 |
| | | Upgrade 0-2% [%] | 30.0 | 45.3 | 36.0 | 28.2 |
| | | Upgrade 2-5% [%] | 14.9 | 9.9 | 15.6 | 15.7 |
| | | Upgrade 5-8% [%] | 10.4 | 1.0 | 1.08 | 8.5 |
| | | Upgrade >8% [%] | 0.3 | 0.1 | 0.0 | 0.7 |
| | | Downgrade 0-2% [%] | 22.5 | 32.5 | 31.3 | 21.7 |
| | | Downgrade 2-5% [%] | 15.2 | 9.7 | 14.5 | 18.8 |
| | | Downgrade 5-8% [%] | 8.5 | 1.4 | 1.5 | 6.0 |
| | | Downgrade >8% [%] | 1.2 | 0.1 | 0.02 | 0.4 |
| | | Maximum incline [%] | 12.2 | 10.2 | 7.3 | 18.3 |
| | | Maximum | −18.9 | −10.1 | −13.7 | −16.2 |
| | | Downgrade [%] | | | | |
| | | 30 | 0.7 | 0.0 | 4.1 | 6.5 |
| | | 50 | 20.8 | 10.8 | 6.8 | 68.2 |
| | | 60 | 2.1 | 1.8 | 1.0 | 3.8 |
| | | 70 | 10.1 | 12.7 | 2.0 | 8.1 |
| | | 80 | 5.8 | 2.7 | 2.2 | 0.0 |
| | | 90 | 0.0 | 0.01 | 0.0 | 0.0 |
| | | 100 | 48.5 | 57.29 | 19.7 | 13.4 |
| | | 120 | 0.0 | 0.1 | 0.0 | 0.0 |
| | | No limitation | 12.0 | 14.6 | 64.2 | 0.0 |
| | | Overtaking ban [%] | 15.0 | 22.9 | 5.6 | 30.4 |
| Type of road | | Federal | 25.1 | 34.2 | 85.7 | 17.7 |
| | | motorway | | | | |
| | | Country | 55.8 | 55.9 | 8.3 | 11.6 |
| | | Urban | 19.1 | 9.9 | 6.0 | 70.7 |
| No. of lanes | | 1-lane | 74.2 | 66.4 | 9.4 | 49.4 |
| | | 2-lane | 25.6 | 18.0 | 63.7 | 44.4 |
| | | 3- and multi- | 0.2 | 15.6 | 26.9 | 6.2 |
| | | lane | | | | |
| Feature/10 km | | Stopping point | 0.1 | 0 | 0.04 | 0.2 |
| | | Observe right | 1 | 0.4 | 0.3 | 1.5 |
| | | of way | | | | |
| | | Traffic lights | 3.4 | 2.6 | 2 | 27 |
| | | Left gives way | 0.05 | 0.03 | 0.1 | 0.6 |
| | | to right | | | | |
| | | Zebra crossing | 0.6 | 0.2 | 0.1 | 2 |
| | | Level crossing | 0.1 | 0.02 | 0 | 0 |
| Pilot speed | Norm | Mean vₚ | 85.0 | 96.0 | 135.4 | 55.2 |
| | | [km/h] | | | | |
| | | Variance [km/h²] | 3.1 | 2.6 | 8.8 | 6.8 |
| | | vₚ Difference [1/h] | 32.7 | 17.7 | 15.6 | 26.7 |
| | F1 | Mean vₚ | 88.2 | 98.0 | 141.2 | 56.2 |
| | | [km/h] | | | | |
| | | Variance [km/h²] | 3.2 | 2.8 | 9.7 | 6.6 |
| | | vₚ Difference [1/h] | 22.2 | 13.0 | 6.0 | 15.8 |

Consequently, according to the invention, macroscopic route features are defined and calculated from the acquired route parameters influencing the journey. It is then a simple matter to use the macroscopic route features to compare two routes with the aid of a few indexes, or to characterize a route or to search for new routes with similar macroscopic route features.

The macroscopic route features can also be used to take account of special user's preferences, which the user specifies in the form of numerical ranges for the indexes of the macroscopic route features. Thus, it is possible, for example, for a motorcycle rider to wish to find a route with a specific horizontal line trace—with many curves—or a combination driver (vehicle with trailer) may prefer a specific horizontal and vertical line trace (few curves and few changes in incline). In addition, the method according to the invention can be used to select test routes for vehicle testing by prescribing specific macroscopic route features for a test drive.

Routes with similar macroscopic route features are sought by comparing the macroscopic route features specified in the form of indexes. The routes which come closest to the desired criteria, are output as recommended routes. It is thus possible to output the first three routes, for example. In this case, it is unimportant whether the user wishes to cover a specific route from A to B, or whether he wishes, for test purposes or for fun, to drive over some route or other which comes closest to the desired macroscopic route features. In addition, it is also possible to allow the user can to prescribe a specific distance from a starting point within which the sought route is to lie.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Assistance system for selecting a route with the aid of a computing device (1), a storage device (2), an input device (4) and an output device (5), each route being described by route parameters influencing the journey and stored in the storage device (2), and whose computing device (1) selects a specific route after an input of search criteria and outputs it via the output device (5), characterized in that the computing device (1) uses the route parameters influencing the journey to determine and store macroscopic route features for each route which can be interrogated by the input of search criteria for macroscopic route features.

2. Assistance system according to claim 1, characterized in that for a route being sought the computing unit (1) compares the input macroscopic route features with the macroscopic route features defined for each route, and selects and outputs the route whose macroscopic route features come closest to the input route features.

3. Assistance system according to claim 1, characterized in that calculated as macroscopic route features from the route parameters influencing the journey are a horizontal line trace and/or a vertical line trace and/or a dynamized pilot speed.

4. Assistance system according to claim 3, characterized in that as macroscopic route features, the vertical line trace comprises a curviness and/or a proportion of curves and/or a classification of the horizontal line trace.

5. Assistance system according to claim 3, characterized in that as macroscopic route features the horizontal line trace comprises a mean incline and/or upgrade and downgrade sections and/or maximum inclines.

6. Assistance system according to claim 3, characterized in that the computing device (1) calculates the. macroscopic route features for prescribable length intervals.

7. Assistance system according to claim 1, characterized in that the macroscopic route features comprise the percentages of speed limitations and/or of overtaking bans and/or of road types and/or of number of lanes.

8. Assistance system according to one of the preceding claims, characterized in that the assistance system is part of a navigation system.

9. Assistance system according to one of the preceding claims, characterized in that the assistance system is used to select test routes for vehicle testing.
